(19) United States
(12) Patent Application Publication
(10) Pub. No.: US 2009/0003150 A1
(43) Pub. Date: Jan. 1, 2009

(54) Method for calibrating focus balance of optical disk drive

(75) Inventors: Miller Yang, Taoyuan (TW); Wei-Ting Huang, Taoyuan (TW); Shih-Jung Huang, Taoyuan (TW)

Correspondence Address: BACON & THOMAS, PLLC, 625 SLATERS LANE, FOURTH FLOOR, ALEXANDRIA, VA, 22314-1176, US

(73) Assignee: QUANTA STORAGE INC., Taoyuan (TW)

(21) Appl. No.: 12/003,977

(22) Filed: Jan. 4, 2008

(30) Foreign Application Priority Data
Jun. 26, 2007 (TW) 96123226

(51) Int. Cl. G11B 7/00

(52) U.S. Cl. 369/44.14; 369/53.11

(57) ABSTRACT

A method for calibrating focus balance of an optical disk drive includes the steps of: zeroing a reference value; presetting a variable and a direction for calibrating the focus balance; generating a new C1C2 signal according to the preset variable for calibrating the focus balance; determining whether the value of the new C1C2 signal is larger than the value of a previous C1C2 signal or not by way of comparing, and changing the direction if yes or otherwise keeping the direction; and checking whether the value of the new C1C2 signal is larger than a threshold value C1C2_{T} or not, and continuing calibrating the focus balance if yes or otherwise ending calibrating so that the focus balance can be rapidly achieved.

This application claims the benefit of Taiwan application Serial No. 96123226, filed Jun. 26, 2007, the subject matter of which is incorporated herein by reference.

### BACKGROUND OF THE INVENTION

1. Field of the Invention

The invention relates in general to an optical disk drive, and more particularly to a method of an optical pickup for calibrating focus balance when an optical disk drive is reading a CD.

2. Description of the Related Art

Data is recorded on an optical disk with extremely dense marks, so an optical disk drive has to project and focus laser beams onto the mark by using an optical pickup, and the mark reflects the laser beams with different intensities, which are converted into digital signals. The digital signals are then decoded into data signals. Thus, whether the laser beams are correctly focused directly influences the intensities of the read signals and the data correctness.

FIG. 1 is a functional block diagram showing a focus balance calibrating device of a conventional optical disk drive. As shown in FIG. 1, the optical disk drive has an optical pickup 1 for projecting light beams 2 onto an optical disk 3, which reflects the light beams 2 to a photodetector 4 through the optical pickup 1. The photodetector 4 has four equally divided light receiving portions A, B, C and D for respectively receiving different parts in the reflected light beams, and converting into electric signals with corresponding intensities. Then, the electric signals are inputted to an amplifier 5, which respectively adds the electric signals of the light receiving portions A and C, and B and D together to generate the electric signals of the portions (A+C) and (B+D), then calculates the result of ((A+C)−(B+D)) to generate a difference signal, and then amplifies the difference signal to generate a focus error signal FE to be transmitted to a compensator 6. The compensator 6 forms a control signal, and a focusing servo unit 7 accordingly controls and calibrates an optical pickup to focus on the mark of the optical disk 3, which is rotating at a high speed with vibrations. Thus, the four light receiving portions of the photodetector 4 can correctly receive the reflected light beams. Then, an amplifier 8 adds the reflected light beams together to form a radio frequency signal RF of (A+B+C+D) to represent the signal of the mark. Thus, the reliability of a modulator 9 for converting the radio frequency signal RF into the data signal can be enhanced.

However, the focus point is a local range with a small dimension, the focus point focused by the focus calibration may not be the strongest position of the radio frequency signal RF. In addition, the focus calibration utilizes the small electric signals as the calculating and judging method, and tends to be influenced by the system error of the disk drive (e.g., the laser light source of the system projects nonuniform light beams, the precision of the optical system, or the four light receiving portions of the photodetector 4 are made of nonuniform light receiving materials. Thus, the real focus point cannot be easily ensured. Therefor, the radio frequency signal RF outputted from the amplifier 8 is converted, by a radio frequency ripple (RFRP) circuit 10, into a RFRP signal with a wave form in another calibration focus apparatus of an optical disk drive. A focus balance unit 11 records and compares several neighboring RFRP signals to find out a strongest RFRP signal and generate an error signal. The compensator 6 generates a control signal according to the error signal and locks the focus point range in conjunction with the focus error signal FE. Then the focusing servo unit 7 controls and calibrates the optical pickup 1 to reach the focus condition of the strongest RFRP signal in order to directly ensure that the optical pickup 1 reads the mark with the strongest radio frequency signal RF to facilitate the decoding.

However, the single radio frequency signal RF only represents the mark with the binary code 1 or 0, and it is not the signal directly outputted from the optical disk drive. Taking the eight to fourteen modulation (EFM) as an example, an original 8-bit digital signal is encoded into a 14-bit mark to form marks on the optical disk with the binary value 1 or 0. Thus, the optical pickup has to completely read the radio frequency signals RFs of the 14-bit mark so that the modulator 9 can correctly decode the radio frequency signals RFs into the 8-bit digital signal. Even if the radio frequency signal RF of the single mark reaches the strongest level, however, the radio frequency signals RFs of other marks in the same set corresponding to the same digital signal cannot be ensured to reach the strongest level. Sometimes, when the strongest radio frequency signal RF is being searched, the calibration focus frequently blurs several marks in the same set corresponding to the same digital signal so that the decoding cannot be smoothly performed and the method of finding the strongest radio frequency signal RF still cannot effectively enhance the overall efficiency of the optical disk drive. Thus, the focus balance calibration method of the conventional disk drive still has some problems to be solved.

### SUMMARY OF THE INVENTION

The invention is directed to a method for calibrating focus balance of an optical disk drive, wherein a focus balance position is automatically adjusted by detecting the decoding quality in the modulation process in order to enhance the overall efficiency of the disk drive.

Another object of the invention is to provide a method for calibrating focus balance of an optical disk drive, wherein the proper focus balance position can be rapidly found by judging the converging direction and speed of the front and rear focus balance.

According to the present invention, a focus balance method for calibrating an optical disk drive is provided. The method includes the steps of: zeroing a reference value; presetting a variable and a direction for calibrating the focus balance; generating a new C1C2 signal according to the preset variable for calibrating the focus balance; determining whether the value of the new C1C2 signal is larger than the value of a previous C1C2 signal or not by way of comparing, and changing the direction if yes or otherwise keeping the direction; and checking whether the value of the new C1C2 signal is larger than a threshold value C1C2_{T} or not, and continuing calibrating the focus balance if yes or otherwise ending calibrating.

The invention will become apparent from the following detailed description of the preferred but non-limiting embodiments. The following description is made with reference to the accompanying drawings.

### BRIEF DESCRIPTION OF THE DRAWINGS

FIG. 1 is a functional block diagram showing a focus balance calibrating device of a conventional optical disk drive.

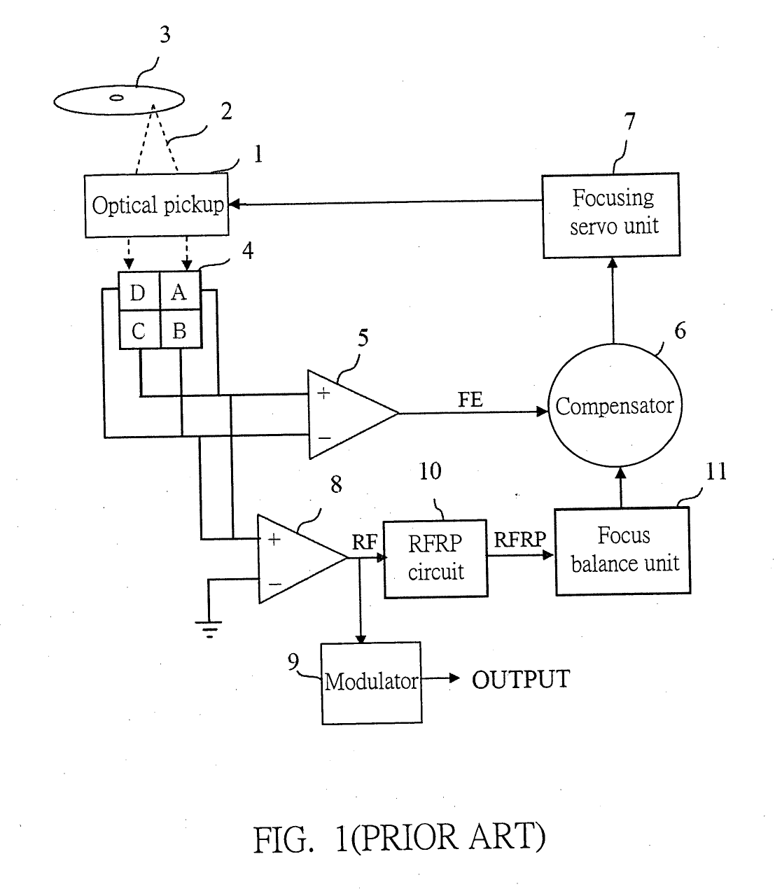

FIG. 2 shows a data structure of a CD.

FIG. 3 is a functional block diagram showing a focus balance calibrating device of an optical disk drive according to the invention.

FIG. 4 is a flow chart showing a method for calibrating focus balance of the optical disk drive according to the invention.

### DETAILED DESCRIPTION OF THE INVENTION

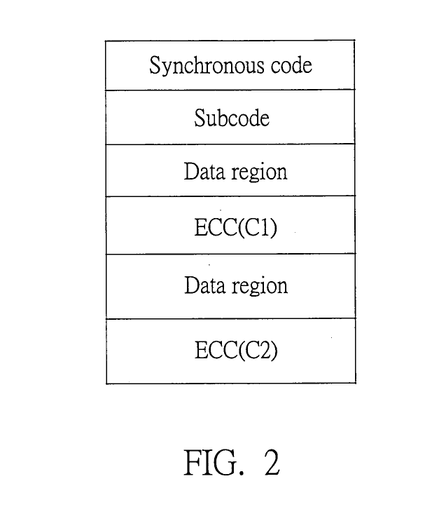

Atypical optical disk, such as a CD, has a helical data track extending from an inner edge to an outer edge. The data track starts from a lead-in region containing a table of contents (TOC). Then, the data track is divided into many sectors, each of which includes 2352 data bytes and 98 subcode bytes and is encoded into 98 frames by the EFM modulation, as shown in FIG. 2. FIG. 2 shows a data structure of each frame, and each frame includes a synchronous code (SYNC), a subcode, a data region, an error correct code (ECC) C1, another data region and an ECC C2, wherein the ECC C1 and C2 are for solving decoding errors, which are newly happened in the data reading process. The last sector is followed by a lead-out region to represent the ending position of the data recorded on the optical disk (CD).

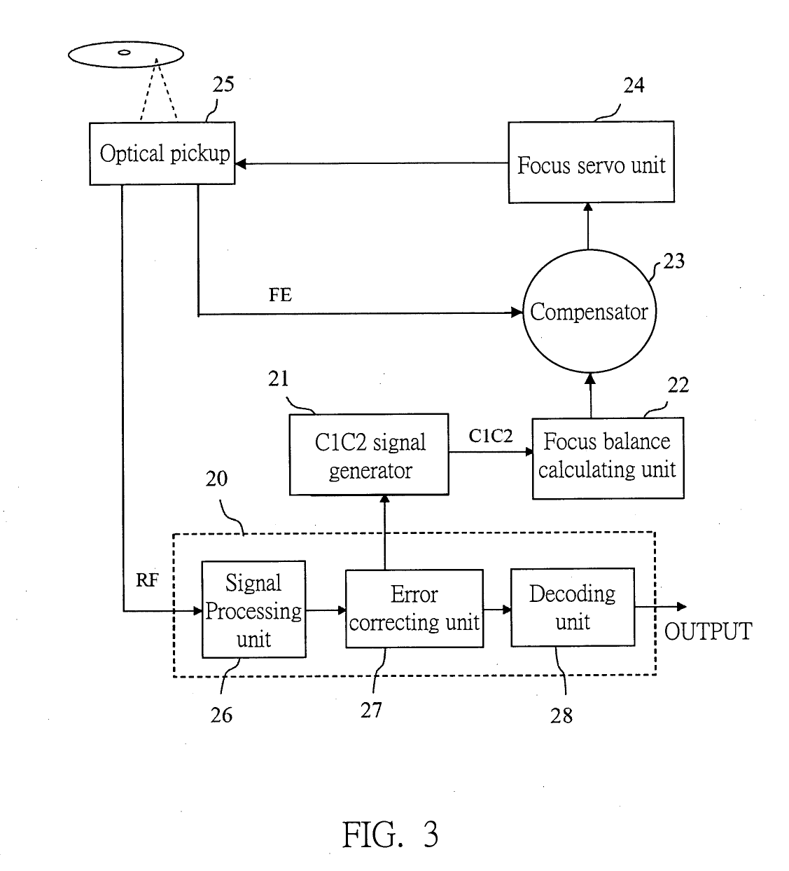

FIG. 3 is a functional block diagram showing a focus balance calibrating device of an optical disk drive according to the invention. Referring to FIG. 3, the focus balance calibrating device of the optical disk drive includes a modulator 20, a C1C2 signal generator 21, a focus balance calculating unit 22, a compensator 23 and a focusing servo unit 24. An optical pickup 25 in the disk drive reads the mark of the optical disk and outputs the radio frequency signal RF. The radio frequency signal RF is decoded and modulated, by the modulator 20, into the digital data signal. Meanwhile, the C1C2 signal generator 21 generates a C1C2 signal according to the decoding quality, and the focus balance calculating unit 22 generates an error signal according to the C1C2 signal. Then, the error signal is transmitted to the compensator 23, and a focus control signal is formed according to the error signal and the focus error signal FE. The focusing servo unit 24 controls the optical pickup 25 to automatically adjust the focus balance position and thus to keep the decoding quality.

The modulator 20 includes a signal processing unit 26, an error correcting unit 27 and a decoding unit 28. The signal processing unit 26 is an analog to digital converter for receiving and converting the radio frequency signals RFs coming from the optical pickup 25 into digital signals (i.e., 0 or 1 in the form of the binary code). The error correcting unit 27 sequentially judges whether the read marks have errors according to the binary codes, which are generated by the signal processing unit 26, so that the correction can be performed. The mark, which is judged as correct, is decoded and modulated, by the decoding unit 28, into the digital signal to serve as an output of the optical disk drive.

During this modulation process, the error correcting unit 27 has to correct the mark to facilitate the decoding modulation. The C1C2 signal generator 21 generates a corresponding C1C2 signal according to the number of times of the newly read errors during the error correcting process. When the value of the C1C2 signal gets larger, it represents that the incorrect read marks get more, and the decoding modulation cannot be performed more easily. On the contrary, when the value of the C1C2 signal gets smaller, it represents that the incorrect read marks get fewer, and the decoding modulation can be easily performed. Therefore, the error correcting unit 27 can perform decoding or display errors and stop the decoding modulation according to the C1C2 signal.

In addition, the focus balance calculating unit 22 compares the value of the C1C2 signals inputted from the C1C2 signal generator 21 mainly by calibrating the focus balance position to judge the converging direction and speed of the focus balance and then properly determines the amount of calibrating the focus balance. The compensator 23 calibrates the up and down movements of the lens of the optical pickup 25 through the focusing servo unit 24 to achieve the focus balance so that the value of the C1C2 signal is kept under the threshold value C1C2_{T}, the decoding process can be performed conveniently, and the overall efficiency of the optical disk drive can be enhanced.

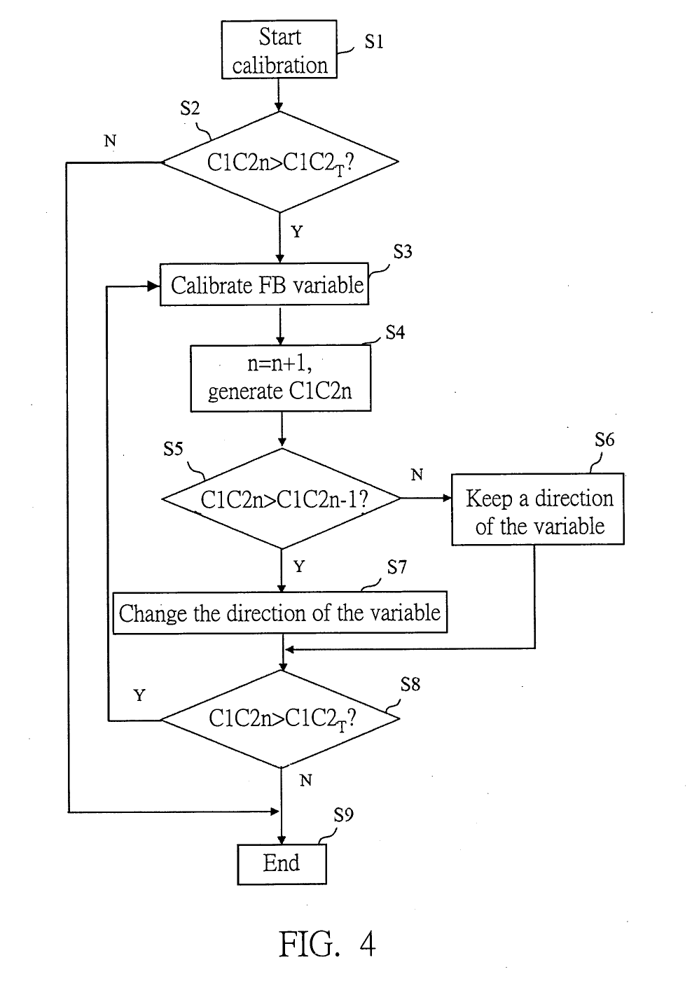

FIG. 4 is a flow chart showing a method for calibrating focus balance of the optical disk drive according to the invention. When there are too many decoding errors to make the value of the C1C2 signal fall without the reasonable range, the invention starts to calibrate the focus balance to make the C1C2 signal return to the level under the threshold value C1C2_{T} as soon as possible according to the converging direction and speed of the value of the C1C2 signal. Before the calibration starts, the optical disk drive presets the variable ΔFB of the calibrating focus balance as a predetermined amount, such as ΔFB=5, sets the converging direction of the focus balance as the increasing direction, and sets the acceptable threshold value of the C1C2 signal as C1C2_{T}. The method for calibrating focus balance includes the following steps S1 to S9.

In the step S1, the calibration of the focus balance starts. First, the reference value FB of the focus balance is zeroed.

In the step S2, the currently inputted C1C2 signal is set as the C1C2n signal, and compared with the threshold value C1C2_{T}. That is, it is checked whether the value of the C1C2n signal is larger than the threshold value C1C2_{T} or not. If the value of the C1C2n signal is smaller than the threshold value C1C2_{T}, which means that the number of the incorrect read marks falls within the acceptable range, the original position of the focus balance is kept and the procedure enters the step S9. If the value of the C1C2n signal is larger than the threshold value C1C2_{T}, that is, if the number of the incorrect read marks does not fall within the acceptable and reasonable range, the number of the incorrect read marks is too great and the position of the focus balance is poor. Thus, the position of the focus balance has to be calibrated, and the procedure enters the next step.

In the step S3, the converging direction of the focus balance is set as the increasing direction, and the position FB of the focus balance is increased by the predetermined amount ΔFB.

In the step S4, the equation of n=n+1 is calculated to generate the new C1C2n signal.

In the step S5, the values of the new C1C2n signal and the previous C1C2n-1 signal are compared with each other. That is, it is checked whether the value of the C1C2n signal is larger than the value of the C1C2n-1 signal. If the value of the C1C2n signal is smaller than the value of the C1C2n-1 signal, the procedure enters the step S6. If the value of the C1C2n signal is larger than the value of the C1C2n-1 signal, the procedure enters the step S7.

In the step 6, when the value of the C1C2n signal is smaller than the value of the C1C2n-1 signal, the increasing direction is the correct converging direction, the default direction of the original variable (i.e., the increasing direction) is kept, and the procedure enters the step S8.

In the step S7, when the value of the C1C2n signal is larger than the value of the C1C2n-1 signal, the increasing direction is the incorrect converging direction, the default direction of the variable (i.e., the increasing direction) is changed to the decreasing direction, and the procedure enters the next step S8.

In the step S8, it is further checked whether the value of the C1C2n signal is larger than the threshold value C1C2_{T} (i.e., it is checked whether the value of the calibrated C1C2n signal falls within the reasonable range. If the value of the C1C2n signal is larger than the threshold value C1C2_{T}, it means that the number of the incorrect read marks is too great, and the position of the focus balance is still poor. Thus, the position of the focus balance still has to be calibrated, and the procedure goes back to the step S3 to continue the calibrating step. If the value of the C1C2n signal is smaller than the threshold value C1C2_{T}, that is, the number of the incorrect read marks falls within the acceptable and reasonable range, the current position of the focus balance is kept and the procedure enters the next step.

In the step S9, as the focus balance has been calibrated and the value of the C1C2n signal is smaller than the threshold value C1C2_{T}, the calibrating step immediately ends.

Therefore, the invention can convert the radio frequency signal RF, outputted from the optical pickup, into the digital signal using the signal processing unit of the modulator, and then the read mark is judged and corrected by the error correcting unit. During the error correcting process, the focus balance calculating unit calculates and compares the correspondingly generated C1C2 signals to check the converging direction and speed of the focus balance, and determines the amount of calibrating the focus balance. The amount of calibrating the focus balance is transmitted to the compensator, and the focus control signal is generated according to the amount of calibrating the focus balance and the focus error signal FE. Then, the focusing servo unit accordingly controls the optical pickup to reach the proper focus balance rapidly. The value of the C1C2 signal is lowered by one set of marks to reduce the generated errors and thus save the operation time of the error correcting unit of correcting the errors. Thus, the decoding unit can smoothly generate and output the digital signal by way of decoding and modulating, and the overall efficiency of the disk drive can be enhanced.

Although the method of calibrating the focus balance according to the embodiment of invention is described with reference to the converging direction of the focus balance, which is preset as the increasing direction, and the variable ΔFB of the focus balance, which is a constant value, the position converging direction of the focus balance may also be set as the decreasing direction, or the variable ΔFB of the focus balance may be non-constant without influencing the object of the invention and departing from the technological scope of the invention.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for calibrating focus balance of an optical disk drive, the method comprising the steps of:
(1) zeroing a reference value;
(2) calibrating a variable ΔFB of the focus balance and generating a new C1C2 signal;
(3) checking whether the value of the new C1C2 signal is larger than a threshold value C1C2_{T} or not, and going back to the step (2) if the value of the new C1C2 signal is larger than the threshold value C1C2_{T}, or otherwise entering the step (4); and
(4) end calibrating.

2. The method according to claim 1, wherein the optical disk drive presets the threshold value of the C1C2 signal as C1C2_{T}.

3. The method according to claim 1, wherein the reference value zeroed in the step (1) is a focus balance reference value FB=0.

4. The method according to claim 1, further comprising, after the step (1), the step of:
(1a) checking whether the value of the C1C2 signal is larger than the threshold value C1C2_{T} or not, and entering the step (4) if the value of the C1C2 signal is smaller than or equal to the threshold value C1C2_{T}, or otherwise entering the step (2).

5. The method according to claim 1, wherein the optical disk drive presets the variable ΔFB and a direction of the focus balance.

6. The method according to claim 5, wherein the variable ΔFB being changed each time in the step (2) of calibrating the focus balance is equal to one predetermined amount.

7. The method according to claim 6, further comprising, after the step (2), the step of:
(2a) determining whether the value of the new C1C2 signal is larger than the value of the previous C1C2 signal or not, and changing the direction of the variable ΔFB and entering the step (3) if the value of the new C1C2 signal is larger than the value of the previous C1C2 signal, or otherwise keeping an original direction of the variable ΔFB and entering the step (3).

8. The method according to claim 7, wherein the direction of the variable ΔFB is set as an increasing direction.

9. The method according to claim 7, wherein the direction of the variable ΔFB is set as an decreasing direction.

10. The method according to claim 7, wherein the variable ΔFB is a non-constant predetermined amount.

11. The method according to claim 7, wherein the variable ΔFB is a constant predetermined amount.
